(19) United States
(12) Patent Application Publication
(10) Pub. No.: US 2026/0010946 A1
(43) Pub. Date: Jan. 8, 2026

(54) METHOD OF OPERATING ONLINE FINANCIAL PRODUCT CORRESPONDING TO TRANSACTION AT ORDER OF PARTICIPATION ENTRY INCLUDED IN ROSCA-TYPE ONLINE FINANCIAL PRODUCT, AND FINANCIAL SERVICE SERVER PERFORMING SAME

(71) Applicant: TWAVE CO., LTD., Busan (KR)

(72) Inventor: Jae Jun SEO, Seoul (KR)

(21) Appl. No.: 19/210,867

(22) Filed: May 16, 2025

Related U.S. Application Data
(63) Continuation of application No. PCT/KR2025/001818, filed on Feb. 7, 2025.

(30) Foreign Application Priority Data
Feb. 8, 2024 (KR) 10-2024-0019336

(51) Int. Cl. G06Q 40/03

(52) U.S. Cl. CPC G06Q 40/0305

(57) ABSTRACT

A method of operating an online financial product corresponding to transaction at the order of a participation entry included in a Rotating Savings and Credit Association (RoSCA)-type online financial product includes receiving a search request message including search condition information for a desired financial product of a user from a user terminal; searching for a first matching financial product, which is a first financial product matching the search condition information among at least one first financial products that have been opened and are in progress; setting detailed information of a first virtual participation entry on the basis of detailed information of the vacant participation entry of the first matching financial product and the search condition information; and transmitting a search completion message including the detailed information of the first virtual participation entry to the user terminal. The method is performed in a financial service server.

### CROSS-REFERENCE TO RELATED APPLICATIONS

This application is a Continuation of International Application No. PCT/KR2025/001818 filed Feb. 7, 2025, which claims priority from Korean Application No. 10-2024-0019336 filed Feb. 8, 2024. The aforementioned applications are incorporated herein by reference in their entireties.

### TECHNICAL FIELD

The embodiments of the present disclosure relate to a method of operating an online financial product corresponding to transaction at order of a participation entry included in a Rotating Savings and Credit Association (RoSCA)-type on line financial product, and a financial service server performing the same.

### RELATED ART

Peer-to-Peer (P2P) finance is a credit loan service between a plurality of lenders and a plurality of borrowers through an open internet marketplace, and has been experiencing rapid growth worldwide. In Korea as well, as the number of low-credit individuals unable to obtain loans from traditional financial institutions increases, financially excluded individuals who cannot use traditional financial institutions can receive loan services through P2P finance.

In particular, a Rotating Savings and Credit Association (RoSCA)-type online financial product, which is similar to the Korean Gye system, is a collective savings system in which each member (i.e., participant) agrees to contribute a fixed amount (i.e., a contribution amount) regularly and takes turns receiving a lump sum (i.e., a payout amount or a substantial amount of money). The lump sum is used for various purposes, such as starting a business, paying tuition fees, and purchasing a house.

Meanwhile, after a plurality of participants is recruited and a RoSCA-type online financial product is opened, a situation may occur in which a specific participant terminates the online financial product due to personal circumstances, non-payment of a contribution amount, etc. In this case, there is a problem in which the remaining participants, excluding the specific participant, or the company operating the online financial product suffers financial risk. Accordingly, there is a need for a solution to resolve financial risks arising from termination of an online financial product by a specific participant.

### SUMMARY

The object of the present disclosure is to provide a method of operating an online financial product that can quickly resolve financial risks arising from termination of a RoSCA-type online financial product, and a financial service server for performing the method.

Further, the object of the present disclosure is to provide a method of operating an online financial product that offers a high agreed interest rate to users and to provide users with services of a RoSCA-type financial product without waiting, and a financial service server for performing the method.

Further, the object of the present disclosure is to provide a method of operating an online financial product, which ensures additional revenue to financial service provider companies, and a financial service server for performing the method.

The objects of the present disclosure are not limited to those described above and other objects and advantages of the present disclosure not stated above may be understood through the following description and may be more clearly understood by the embodiments of the present disclosure. Further, it will be easily known that the objects and advantages of the present disclosure may be achieved by the means described in the claims and a combination thereof.

A method of operating an online financial product according to an embodiment of the present disclosure is a method that is performed in a financial service server and operates a Rotating Savings and Credit Association (RoSCA)-type online financial product, and includes receiving a search request message including search condition information for a desired financial product of a user from a user terminal, searching for a first matching financial product, which is a first financial product matching the search condition information among at least one first financial products that have been opened and are in progress, setting detailed information of a first virtual participation entry on the basis of detailed information of the vacant participation entry of the first matching financial product and the search condition information, and transmitting a search completion message including the detailed information of the first virtual participation entry to the user terminal. In this case, a plurality of participation entries of the first financial product includes a vacant participation entry in which a participant has terminated or is scheduled to terminate the first financial product.

A financial service server that operates a RoSCA-type online financial product according to an embodiment of the present disclosure includes a communication unit receiving a search request message including search condition information for a desired financial product of a user from a user terminal; and a processor unit searching for a first matching financial product, which is a first financial product matching the search condition information among at least one first financial products that have been opened and are in progress, and setting detailed information of a first virtual participation entry on the basis of detailed information of the vacant participation entry of the first matching financial product and the search condition information. In this case, a plurality of participation entries of the first financial product include a vacant participation entry in which a participant has terminated or is scheduled to terminate the first financial product, and the communication unit transmits a search completion message including the detailed information of the first virtual participation entry to the user terminal.

According to the present disclosure, it is possible to quickly resolve financial risks arising from termination of a RoSCA-type online financial product.

Further, according to the present disclosure, it is possible to offer a high agreed interest rate to users and provide users with services of a RoSCA-type financial product without waiting.

Further, according to the present disclosure, it is possible to ensure additional revenue for financial service provider companies.

Further, the effects of the present disclosure are not limited to the above effects and it should be understood that the effects include all effects that can be inferred from the configuration of the present disclosure described in the detailed description or the claims of the present disclosure.

### BRIEF DESCRIPTION OF THE DRAWINGS

FIG. 1 is a diagram showing the schematic configuration of a system for operating an online financial service according to an embodiment of the present disclosure.

FIG. 2 is a diagram showing the schematic configuration of a financial service server according to an embodiment of the present disclosure.

FIG. 3 is a diagram illustrating the concept of a RoSCA-type online financial product according to an embodiment of the present disclosure.

FIG. 4 is a diagram illustrating the overall process flow of a method of operating a RoSCA-type financial product according to an embodiment of the present disclosure.

FIGS. 5A, 5B, and 5C are diagrams illustrating an example of a first financial product including a vacant participation entry according to an embodiment of the present disclosure.

FIG. 6 is a diagram illustrating the concept of a virtual online financial product according to an embodiment of the present disclosure.

FIG. 7 is a diagram illustrating an example of a second financial product including a recruitment participation entry according to an embodiment of the present disclosure.

### DETAILED DESCRIPTION

The present disclosure may be modified in various ways and implemented by various exemplary embodiments, so that specific exemplary embodiments are shown in the drawings and will be described in detail. However, it is to be understood that the present disclosure is not limited to the specific exemplary embodiments, but includes all modifications, equivalents, and substitutions included in the spirit and the technical scope of the present disclosure. Similar reference numerals are assigned to similar components in describing each drawing.

Although the terms “first”, “second”, etc. may be used herein to describe various components, these components should not be limited by these terms. The above terms are used only to discriminate one component from another component. The term “and/or” includes a combination of a plurality of relevant items or any one of a plurality of relevant items.

It is to be understood that when an element is referred to as being “connected to” or “coupled to” another element, it may be directly connected to or directly coupled to another element or be connected to or coupled to another element with the other element therebetween. On the other hand, it is to be understood that when an element is referred to as being “directly connected to” or “directly coupled to” another element, it may be connected to or coupled to another element without the other element therebetween.

The terms used in the present specification are used only to describe specific exemplary embodiments rather than limiting the present disclosure. Singular forms include plural forms unless the context clearly indicates otherwise. It will be further understood that the terms “comprises” or “have” as used in this specification are intended to designate the presence of stated features, numbers, steps, operations, components, parts, or a combination thereof, but not to preclude the possibility of the presence or addition of one or more other features, numbers, steps, operations, components, parts, or a combination thereof.

Unless defined otherwise, all the terms used herein including technical or scientific terms have the same meanings as those that are generally understood by those having ordinary skill in the art to which the present invention pertains. The terms such as those defined in common dictionaries should be construed as having a meaning consistent with their meanings in the context of the relevant art, and should not be construed in an idealized or overly formal sense unless expressly so defined herein.

Hereinafter, exemplary embodiments of the present disclosure will be described in detail with reference to the accompanying drawings.

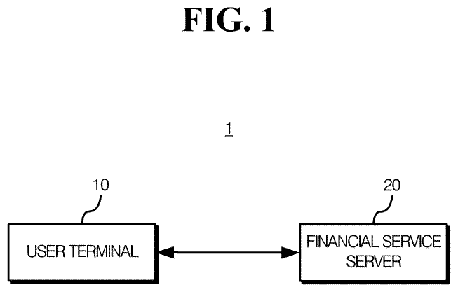

FIG. 1 is a diagram showing the schematic configuration of a system 1 for operating an online financial service according to an embodiment of the present disclosure.

Referring to FIG. 1, the system 1 for operating an online financial service may include a user terminal 10 and a financial service server 20.

The user terminal 10 may be a process-based device owned by a user. For example, the user terminal 10 may also be referred to as various names such as a mobile terminal, a wireless device, a wireless transmit/receive unit, or a mobile subscriber unit. For example, the user terminal 10 may be a smart phone, a tablet PC, or a laptop.

A client-side financial application for providing an online financial service may be installed on the user terminal 10. The client-side financial application can be executed by a processor unit of the user terminal 10.

The financial service server 20 is connected to the user terminal 10 for communication purposes, and a server-side financial application may be installed therein. The server-side financial application can serve various online financial products by interworking with the client-side financial application.

Meanwhile, as described below, the online financial product may be a Rotating Savings and Credit Association (RoSCA)-type online financial product. The RoSCA-type online financial product may include a plurality of participation entries in which a plurality of users participate. Accordingly, although not clearly shown in FIG. 1, there may be a plurality of user terminals 10. The RoSCA-type online financial product will be described in more detail below.

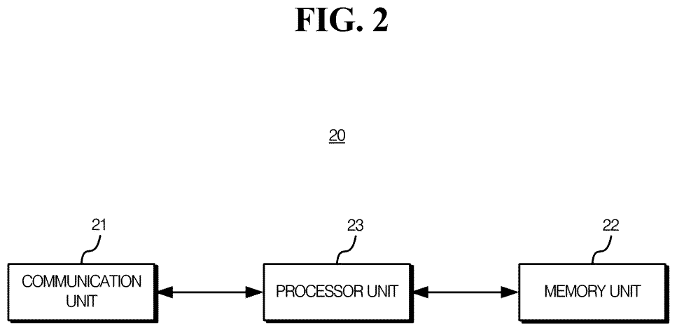

FIG. 2 is a diagram showing the schematic configuration of the financial service server 20 according to an embodiment of the present disclosure.

Referring to FIG. 2, the financial service server 20 may include a communication unit 21, a memory unit 22, and a processor unit 23.

The communication unit 21 can communicate with the user terminal 10. For example, the communication unit 21 may be a short-range communication module and/or a long-range communication module. The short-range communication module may be a communication module based on Bluetooth, Radio Frequency Identification (RFID), infrared Data Association (IrDA), Ultra-Wideband (UWB), ZigBee, or Wireless fidelity (WiFi). The long-range communication module may be a communication module based on code division multiple access (CDMA), frequency division multiple access (FDMA), time division multiple access (TDMA), orthogonal frequency division multiple access (OFDMA), or single carrier frequency division multiple access (SCFDMA).

The memory unit 22 may be volatile and/or a nonvolatile memory and can store instructions or data related to at least one other component of the financial service server 20. Particularly, the memory unit 22 can store instructions or data related to a computer program, an application, a recording medium, etc. operated in the financial service server 20. Particularly, the computer program/application may be for serving online financial products.

The processor unit 23 may include one or more of a central processing unit, an application processor, or a communication processor. The processor unit 13 can perform calculation or data processing about control and/or communication of at least one other components of the management server 10. Particularly, the processor unit 23 can execute the instructions of the computer program/application.

Although not shown in FIG. 2, the financial service server may further include a display unit, a storage unit, etc.

Hereafter, a RoSCA-type online financial product that is provided by the financial service server 20 is described in detail.

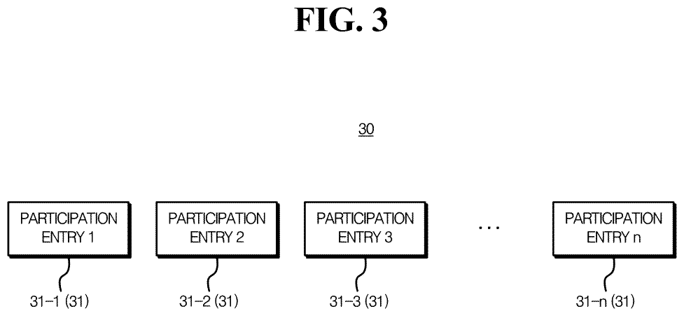

FIG. 3 is a diagram for explaining the concept of a RoSCA-type online financial product 30 according to an embodiment of the present disclosure.

Hereafter, for the convenience of description, the RoSCA-type online financial product is referred to as a “ROSCA financial product 30”.

Referring to FIG. 3, the RoSCA financial product 30 may include a plurality of, that is, N (an integer of 2 or more) participation entries 31. In this case, the RoSCA financial product 30 may be referred to as a “stage” and the N participation entries 31 may be referred to as “N stage participation spaces”.

The RoSCA financial product 30 may be created by a specific user, that is, a creating user, and N participating users, including the creating user, can participate in the N participation entries 31.

The N participation entries 31 can be assigned with sequential orders. In accordance with the order assigned to each of the N participation entries 31, at least one of a payout amount (i.e., a lump sum, a disbursement amount, or a maturity amount), an agreed interest rate, and a contribution amount (e.g., monthly contribution amount) may be set for each participation entry 31.

In detail, a RoSCA financial product 30 that has N participation entries 31 with sequential orders and in which a total of N contribution amounts are paid and one maturity amount is disbursed may be created. Each participating user is required to pay a total of N contribution amounts and can receive one maturity amount, and the timing of maturity amount disbursement may be determined on the basis of the orders of the participation entries 31. For the convenience of description, it is assumed that the number of the participation entries 31 and the number of payment rounds of the contribution amount are the same. However, the present disclosure is not limited thereto, and the number of the participation entries 31 and the number of payment rounds of the contribution amount may be different.

The contribution amounts of each participating user (i.e., the first to nth contribution amounts) may be set to be different from each other in accordance with the orders of the corresponding participation entries 31, and the maturity amounts of each participating user may be set to be the same regardless of the orders of the participation entries 31. Alternatively, the contribution amounts of each participating user may be set to be the same regardless of the orders of the participation entries 31, and the maturity amounts of each participating user may be set to be different from each other in accordance with the orders of the corresponding participation entries 31. Further, the participating user who joined the nth (n is an integer from 1 to N) participation entry 31 of the N participation entries 31 can receive the maturity amount in the nth payment round.

Each participating user can select the order of the participation entries 31 in accordance with the purpose of using the RoSCA financial product 30.

In detail, a user who urgently needs a substantial amount of money can participate in a participation entry 31 with an earlier order among the N participation entries 31. In this case, the agreed interest rate of a participation entry 31 with an earlier order may be a negative agreed interest rate, and the user can receive the maturity amount earlier, but there is a drawback that the maturity amount becomes smaller than the total contribution amounts. As another example, a user who seeks financial income (e.g., interest) can participate in a participation entry 31 with a later order among the N participation entries 31. This case has the advantage that the agreed interest rate for a participation entry 31 with a later order may be a positive agreed interest rate, and the user benefits from receiving a maturity amount greater than the total payment, but has the drawback that the maturity amount is received later.

In other words, a user participating in a participation entry 31 with a relatively earlier order can use the RoSCA financial product 30 for loan purposes, whereas a user participating in a participation entry 31 with a relatively later order can use the RoSCA financial product 30 for investment purposes. For example, when five participation entries 31 exist, participating users of participation entries 31 with orders 1 and 2 can use the ROSCA financial product 30 for loan purposes, whereas participating users of participation entries 31 with orders 4 and 5 can use the RoSCA financial product 30 for investment purposes.

Hereafter, the operation of the financial service server 20 operating a RoSCA-type online financial product is described based on the description of FIG. 3.

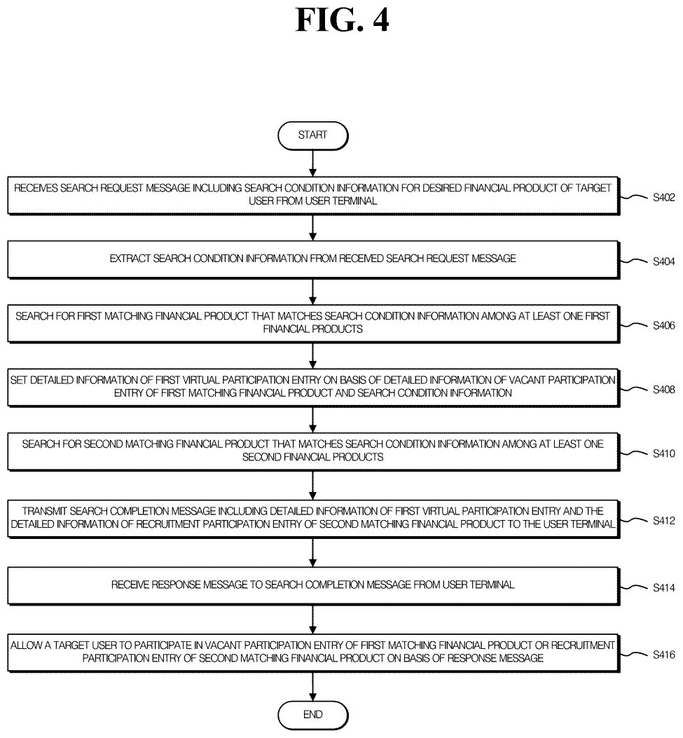

FIG. 4 is a diagram illustrating the overall process flow of a method of operating a RoSCA-type financial product according to an embodiment of the present disclosure.

The method of operating a RoSCA-type financial product can be served through interworking of a server-side financial application that is executed in the financial service server 20 and a client-side financial application that is executed in the user terminal 10.

Hereafter, the process of the steps, which constitute the method of operating a RoSCA financial product, is described in detail on the basis of the financial service server 20.

In step S402, the financial service server 20 can receive a search request message including search condition information for a desired financial product of a target user from the user terminal 10.

In this case, the desired financial product may be a RoSCA-type online financial product that the target user wants to receive the service. Hereinafter, for convenience of description, the ROSCA financial product 30 is referred to as a “financial product 30”.

According to an embodiment, the search condition information may include a desired payout amount, a desired agreed interest rate, and a desired receipt time.

The desired payout amount may be a payout amount (i.e., a lump sum) that a target user wishes to receive. The desired payout amount may be set as a specific amount or amount range.

The desired agreed interest rate may be an agreed interest rate that a target user wants. When a target user utilizes the financial product for loan purposes, the agreed interest rate may be a negative agreed interest rate, and when a target user utilizes the financial product for investment purposes, the agreed interest rate may also be a positive interest rate. The desired agreed interest rate may be set as a specific interest rate or interest rate range.

The desired receipt time may be the time at which a target user wants to receive a desired payout amount. In this case, the desired receipt time may be set on the basis of the current time corresponding to the time at which a target user inputs search conditions through the user terminal 10 or the time at which a search request message is received. The desired receipt time may also be the order of a participation entry included in a desired financial product. For example, the desired receipt time may be set to “order 2” or “two months from the current time”.

Meanwhile, the search condition information may further include a desired contribution amount. For example, the desired contribution amount may be a monthly contribution amount that a target user pays per round.

In step S404, the financial service server 20 can extract the search condition information from the received search request message.

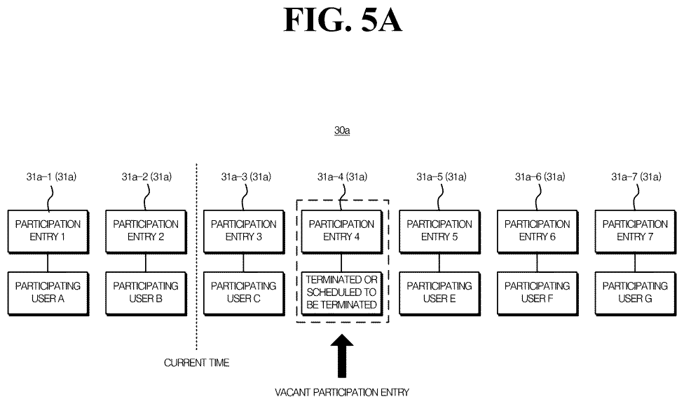

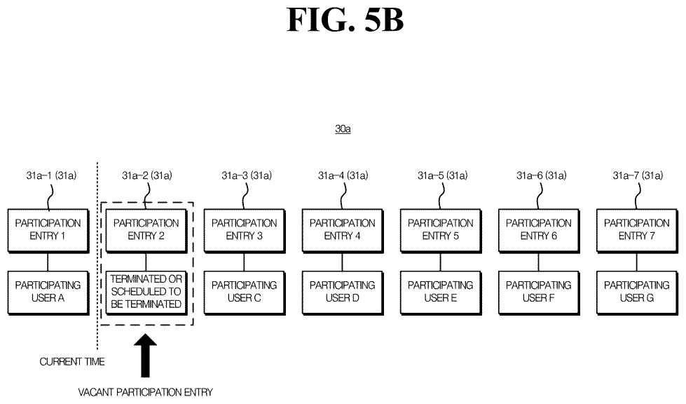

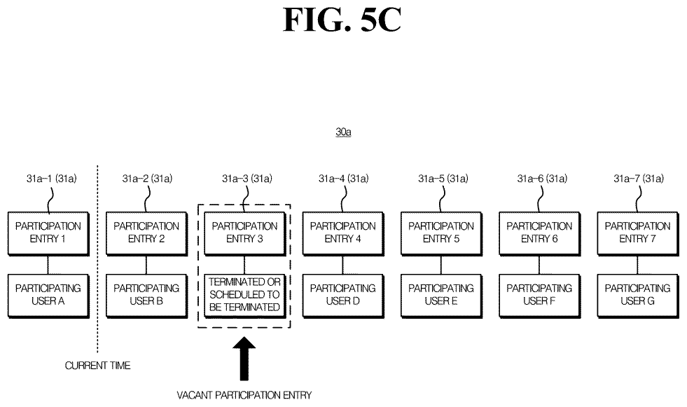

In step S406, the financial service server 20 can search for a first matching financial product 30a, which is a first financial product 30a that matches the search condition information among at least one first financial products 30a (see FIGS. 5A, 5B, and 5C).

In this case, the first financial product 30a may be a financial product that has been opened, in which a plurality of participating users have been recruited, and of which the service is currently in progress. As of the current time, the first financial product 30a may be a financial product in which a participant of a specific participation entry 31 among a plurality of participation entries 31 constituting the first financial product has terminated or is scheduled to terminate the first financial product without receiving the payout amount (i.e., the maturity amount). The specific participation entry described above may be referred to as a “vacant participation entry”.

For example, when a specific participant fails to pay a contribution amount (monthly contribution amount) for a certain period, the financial service server 20 may forcibly expel the specific participant from the first financial product 30a, and accordingly, the first financial product 30a of the specific participant may be forcibly terminated. As another example, a specific participant may voluntarily terminate the first financial product 30a due to personal circumstances. Accordingly, the participation entry of the specific participant may be converted into a vacant participation entry. Meanwhile, as described above, a vacant participation entry may be created (i.e., converted) not only when termination of the first financial product 30a of a participating user has been completed, but also when termination of the first financial product 30a of a participating user is scheduled.

FIGS. 5A, 5B, and 5C illustrate examples of the first financial product 30a including the vacant participation entry 31a.

Referring to FIG. 5A, in a first financial product 30a including seven participation entries 31a, a participating user D, who participated in a participation entry 4 (31a-4), has terminated or is scheduled to terminate the first financial product without receiving a payout amount (i.e., a maturity amount). In this case, the participation entry 4 (31a-4) is converted into a vacant participation entry 31a.

Referring to FIG. 5B, in the first financial product 30a including seven participation entries 31a, a participating user B, who participated in a participation entry 2 (31a-2), has terminated or is scheduled to terminate the first financial product without receiving a payout amount (i.e., a maturity amount). In this case, the participation entry 2 (31a-2) is converted into a vacant participation entry 31a.

Referring to FIG. 5C, in the first financial product 30a including seven participation entries 31a, a participating user C, who participated in a participation entry 3 (31a-3), has terminated or is scheduled to terminate the first financial product without receiving a payout amount (i.e., a maturity amount). In this case, the participation entry 3 (31a-3) is converted into a vacant participation entry 31a.

According to an embodiment, the vacant participation entry 31a of the first financial product 30a may have detailed information including a payout amount, an agreed interest rate, and an order. The financial service server 20 can search for, as a first matching financial product 30a, a first financial product 30a, i) having a receipt time of the payout amount of the vacant participation entry 31a of a first financial product 30a that matches a desired receipt time, ii) having a payout amount of the vacant participation entry 31a of a first financial product 30a corresponding to a desired payout amount; and iii) having a agreed interest rate of the vacant participation entry 31a of a first financial product 30a greater than a desired agreed interest rate, among at least one first financial products 30a. In this case, the receipt time of the payout amount of the vacant participation entry 31a of the first financial product 30a may be calculated on the basis of the reception time of a search request message (i.e., the current time) and the order of the vacant participation entry 31a of the first financial product 30a.

For example, the vacant participation entry 31a of the first financial product 30a in FIG. 5A has a payout amount of “10 million KRW”, a agreed interest rate of “0%”, and an order of “order 4”, the vacant participation entry 31a of the first financial product 30a in FIG. 5B has a payout amount of “10 million KRW”, a agreed interest rate of “−5.26%”, and an order of “order 2”, and the vacant participation entry 31a of the first financial product 30a in FIG. 5C has a payout amount of “10 million KRW”, a agreed interest rate of “−4.12%”, and an order of “order 3”. In this case, it is assumed that a desired payout amount is set to “10 million KRW”, a desired agreed interest rate is set to “−3.5%”, and a desired receipt time is set to “order 2” or “receipt time: 2 months”. Meanwhile, the receipt time of the payout amount of the vacant participation entry 31a of the first financial product 30a in FIG. 5A is 2 months from the current time, the receipt time of the payout amount of the vacant participation entry 31a of the first financial product 30a in FIG. 5B is 1 month from the current time, and the receipt time of the payout amount of the vacant participation entry 31a of the first financial product 30a in FIG. 5C is 2 months from the current time.

In the situation described above, the financial service server 20 may select the first financial products 30a in FIG. 5A and FIG. 5C that have the receipt time of the payout amount of the vacant participation entry 31a of the first financial product 30a matching the desired receipt time, and then select the first financial product 30a in FIG. 5A that has the agreed interest rate of the vacant participation entry 31a greater than the desired agreed interest rate. The selected first financial product 30a in FIG. 5A may be retrieved as a first matching financial product 30a.

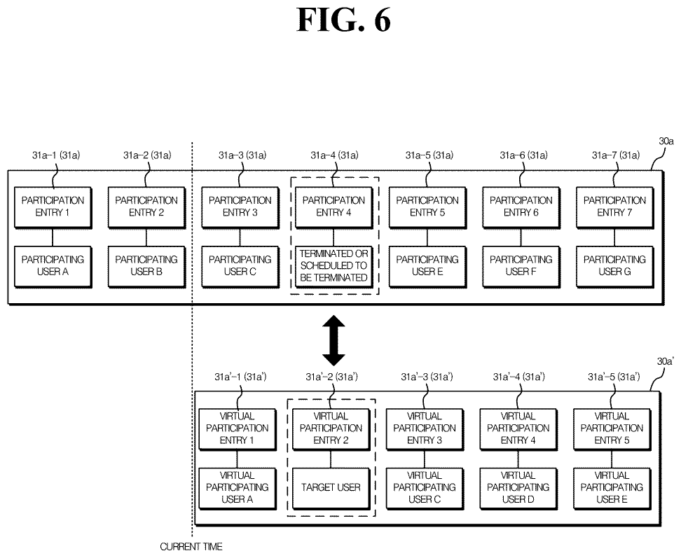

Referring to FIG. 4 again, in step S408, the financial service server 20 can set detailed information of a first virtual participation entry 31a′ (see FIG. 6) on the basis of the detailed information of the vacant participation entry 31a of the first matching financial product 30a and the search condition information.

In detail, a virtual financial product 30a′ (see FIG. 6) that is created to allow a target user to participate in the vacant participation entry 31a of the first matching financial product 30a is defined. The virtual financial product 30a′ is a financial product that is not actually served.

The virtual financial product 30a′ may include a plurality of virtual participation entries 31a′, and a target participant may participate in a first virtual participation entry 31a′ among the plurality of virtual participation entries 31a′.

According to an embodiment, since the first matching financial product 30a is a financial product currently being served, that is, in progress, the number of the plurality of virtual participation entries 31a′ included in the virtual financial product 30a′ may be set to be smaller than the number of the plurality of participation entries 31a of the first matching financial product 30a.

FIG. 6 is a diagram illustrating the concept of a virtual financial product 30a′ according to an embodiment of the present disclosure.

Referring to FIG. 6, when a first matching financial product 30a includes seven participation entries 31a, a virtual financial product 30a′ including five virtual participation entries 31a′ may be created on the basis of the current time (i.e., the reception time of a search request message), the vacant participation entry 31a of the first matching financial product 30a, and a desired receipt time.

In this case, based on the desired receipt time, a target user can participate in a virtual participation entry 2 (31a′-2), which is a first virtual participation entry 31a′ among five virtual participation entries 31a′, and the virtual participation entry 2 (31a′-2) corresponds to a participation entry 4 (31a-4), which is the vacant participation entry 31a of the first matching financial product 30a.

According to an embodiment, the detailed information of the first virtual participation entry 31a′ may include a payout amount, an agreed interest rate, and an order. In this case, the financial service server 20, i) can set a payout amount of the first virtual participation entry 31a′ to be the same as a payout amount of the vacant participation entry 31a of the first matching financial product 30a, ii) can set a agreed interest rate of the first virtual participation entry 31a′ to be lower than the agreed interest rate of the vacant participation entry 31a of the first matching financial product 30a and higher than a desired contract interest rate, and iii) can set the order of the first virtual participation entry 31a′ on the basis of the current time (i.e., a reception time of a search request message) and a desired receipt time.

As described above, in the example of FIG. 6, the payout amount, agreed interest rate, and order of the vacant participation entry 31a of the first matching financial product 30a are set to “10 million KRW,” “0%,” and “order 4,” respectively, and the desired payout amount, desired agreed interest rate, and desired receipt time are set to “10 million KRW,” “−3.5%,” and “order 2,” respectively. In this case, the financial service server 20 can set the payout amount of the first virtual participation entry 31a′ to “10 million KRW,” set the agreed interest rate of the first virtual participation entry 31a′ to an interest rate that is lower than-3.5% and higher than 0% (for example, “−1.0%”), and set the order of the first virtual participation entry 31a′ to “order 2”.

Meanwhile, since the number of participation entries 31a of the first matching financial product 30a is greater than the number of the virtual participation entries 31a′ of the virtual financial product 30a′, the financial service server 20 can set the contribution amount (monthly contribution amount) of the first virtual participation entry 31a′ to be greater than the contribution amount of the vacant participation entry 31a of the first matching financial product 30a. In an example of FIG. 6, the contribution amount of the first virtual participation entry 31a′ can be set to “2 million KRW”, which is greater than 1.43 million KRW that is the contribution amount of the vacant participation entry 31a of the first matching financial product 30a.

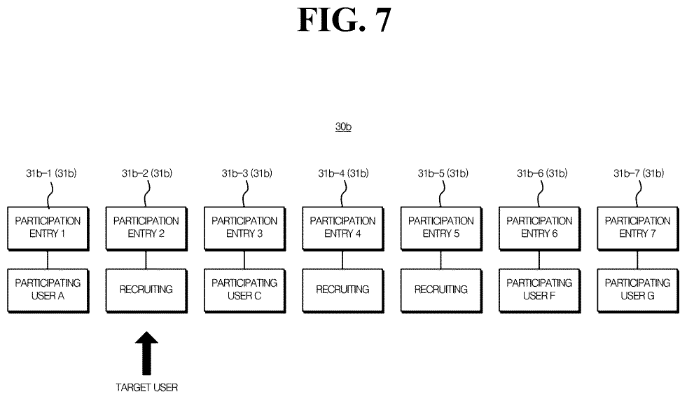

Referring to FIG. 4 again, in step S410, the financial service server 20 can search for a second matching financial product 30b, which is a second financial product 30b that matches search condition information among at least one second financial products 30b (see FIG. 7).

In this case, the second financial product 30b may be a financial product that has not yet been opened. That is, the second financial product 30b may be a financial product that is currently recruiting participating users.

According to an embodiment, the financial service server 20 can search for a second financial product 30b, which includes a recruitment participation entry 31b (see FIG. 7) that matches search condition information among one or more second financial products 30b, as a second matching financial product 30b. In this case, the recruitment participation entry 31b may be a participation entry 31b in which no participating user has yet participated and which matches search condition information.

FIG. 7 shows an example of a second financial product 30b including a recruitment participation entry 31b.

Referring to FIG. 7, the second financial product 30b includes seven participation entries 31b, and among the seven participation entries 31b, participation entry 2 (31b-2), participation entry 4 (31b-4), and participation entry 5 (31b-5) are currently recruiting participants. As described above, it is assumed that a desired payout amount, a desired agreed interest rate, and the desired receipt time are set to “10 million KRW”, “−3.5%”, and “order 2”, respectively. In this case, when the payout amount, the agreed interest rate, and the order, which are the detailed information of participation entry 2 (31b-2), are set to “10 million KRW”, “−3.42%”, and “order 2”, respectively, the financial service server 20 may search for the second financial product 30b of FIG. 7, which includes the participation entry 2 (31b-2) as a recruitment participation entry 31b, from at least one second financial product 30b.

Referring to FIG. 4 again, in step S412, the financial service server 20 can transmit a search completion message including the detailed information of the first virtual participation entry 31a′ and the detailed information of the recruitment participation entry 31b to the user terminal 10.

For example, the financial service server 20 can transmit, to the user terminal 10, the second matching financial product 30b including information of the virtual financial product 30a′ including the detailed information of the first virtual participation entry 31a′ and detailed information of the recruitment participation entry 31b.

In step S414, the financial service server 20 can receive a response message to a search completion message from the user terminal 10.

In detail, when a target user wants to participate in the first virtual participation entry 31a′, the user terminal 10 can transmit, to the financial service server 20, a response message corresponding to a participation request message for the first virtual participation entry 31a′. Alternatively, when a target user wants to participate in the recruitment participation entry 31b, the user terminal 10 can transmit, to the financial service server 20, a response message corresponding to a participation request message for the recruitment participation entry 31b.

In step S416, the financial service server 20 can allow the target user to participate in the vacant participation entry 31a of the first matching financial product 30a or the recruitment participation entry 31b of the second matching financial product 30b, on the basis of the response message.

According to an embodiment, when a response message corresponding to a participation request message for the first virtual participation entry 31a′ is received from the user terminal 10, the financial service server 20 can allow a target user to participate, as a new participant (i.e., a participating user), in the vacant participation entry 31a of the first matching financial product 30a instead of the existing participant of the vacant participation entry 31a of the first matching financial product 30a.

Meanwhile, although not shown in FIG. 4, after step S416, the financial service server 20 can transmit a first participation response message indicating that “a target user has completed participation in the first virtual participation entry 31a” to the user terminal 10, and can transmit a second participation response message indicating that “a target user has completed participation in the vacant participation entry 31a of the first matching financial product 30a” to the user terminals of the remaining participating users of the first matching financial product 30a, excluding users who have cancelled their participation.

Referring to the above description, from the perspective of the target user, the target user recognizes that he/she has participated in the first virtual participation entry 31a′ of the virtual financial product 30a′. In this case, the detailed information of the first virtual participation entry 31a′ is actually applied to the target user. Further, from the perspective of the remaining participating users of the first matching financial product 30a, excluding the users who have cancelled their participation, the target user may be recognized as having participated in the vacant participation entry 31a of the first matching financial product 30a. In this case, the remaining participating users recognize that the detailed information of the vacant participation entry 31a of the first matching financial product 30a is applied to the target user.

According to another embodiment, when a response message corresponding to a participation request message for the recruitment participation entry 31b is received from the user terminal 10, the financial service server 20 can allow a target user to participate in the recruitment participation entry 31b of the second matching financial product 30b as a participant (i.e., a participating user). In this case, the detailed information of the recruitment participation entry 31b is actually applied to the target user. That is, the above-described content may be a participating user recruitment for general participation entry.

In summary, a target user can participate in the first virtual participation entry 31a′ or the recruitment participation entry 31b by checking the detailed information of the first virtual participation entry 31a′ and the recruitment participation entry 31b, by checking a search completion message through the user terminal 10.

As described above, the first virtual participation entry 31a′ corresponds to the vacant participation entry 31a of the first matching financial product 30a. As described above, the first matching financial product 30a is a financial product that is currently being served, that is, in progress. Further, the agreed interest rate of the first virtual participation entry 31a′ is set to be higher than a desired agreed interest rate and lower than the agreed interest rate of the vacant participation entry 31a of the first matching financial product 30a. Further, the agreed interest rate of the recruitment participation entry 31b is almost the same as the desired agreed interest rate.

Accordingly, when a target user selects and participates in the first virtual participation entry 31a′, the target user can be provided with a higher agreed interest rate than a desired agreed interest rate or the agreed interest rate of the recruitment participation entry 31b, and since the first matching financial product 30a has already been opened, the user can be provided with the service of the first matching financial product 30a without waiting, i.e., immediately. Further, there is the advantage that a financial service provider company corresponding to the financial service server 20 can quickly resolve financial risks arising from the participation users who have terminated the first matching financial product 30a, and can gain additional revenue in accordance with the agreed interest rate of the first virtual participation entry 31a′, which is set to be lower than the agreed interest rate of the vacant participation entry 31a of the first matching financial product 30a.

Meanwhile, the configuration in which “a target user participates as a new participant of the vacant participation entry 31a of the first matching financial product 30a by selecting the first virtual participation entry 31a′” can correspond to a configuration in which “a canceled participant (existing participant) sells (trades) the order of the vacant participation entry 31a of the first matching financial product 30a”. That is, the method of operating an online financial product described in this specification may include a method of trading the order of a participation entry included in a RoSCA-type online financial product.

Further, the embodiments of the present disclosure may be implemented in the form of program commands that can be executed by means of various computers and recorded on computer-readable media. The computer-readable media may include program commands, data files, and data structures individually or in combinations thereof. The program commands recorded on the media may be those specially designed and configured for the present invention or may also be those known and available to those engaged in computer software in the art. The computer-readable recording media include magnetic media such as hard disks, floppy disks, and magnetic tape; optical media such as CD-ROMs and DVDs; magneto-optical media such as floptical disks; and hardware devices specially configured to store and execute program commands, such as ROM, RAM, and flash memory. The program commands include not only machine language codes compiled by a compiler, but also high-level language code that can be executed by a computer using an interpreter etc. The hardware device may be configured to operate as one or more software modules to perform the operation of embodiments of the present disclosure, and vice versa.

Hereinabove, although the present disclosure is described by specific matters such as concrete components, and the like, limited embodiments, and drawings, they are provided only for assisting in the entire understanding of the present disclosure. Therefore, the present disclosure is not limited to the embodiments, and various modifications and variations can be made by those skilled in the art to which the present disclosure pertains from this description. Therefore, the spirit of the present disclosure should not be limited to the above-described embodiments, and the following claims as well as all things modified equally or equivalently to the claims will be considered to fall within the scope of the present disclosure.

What is claimed is:

1. A method of operating an online financial product that is performed in a financial service server and operates a Rotating Savings and Credit Association (RoSCA)-type online financial product, the method comprising:
receiving a search request message including search condition information for a desired financial product of a user from a user terminal;
searching for a first matching financial product, which is a first financial product matching the search condition information among at least one first financial products that have been opened and are in progress, wherein a plurality of participation entries of the first financial product includes a vacant participation entry in which a participant has terminated or is scheduled to terminate the first financial product;
setting detailed information of a first virtual participation entry on the basis of detailed information of the vacant participation entry of the first matching financial product and the search condition information; and
transmitting a search completion message including the detailed information of the first virtual participation entry to the user terminal.

2. The method of claim 1, further comprising:
after the transmitting of the search completion message to the user terminal, allowing the user to participate as a new participant of the vacant participation entry of the first matching financial product instead of a participant of the vacant participation entry of the first matching financial product when a participation request message for the first virtual participation entry, which is response to the search completion message, is received from the user terminal,
wherein the detailed information of the first virtual participation entry is applied to the user participating in the vacant participation entry of the first matching financial product.

3. The method of claim 1, wherein the search condition information includes a desired payout amount, a desired agreed interest rate, and a desired receipt time of the desired payout amount, and
wherein the detailed information of the vacant participation entry of the first financial product includes a payout amount, an agreed interest rate, and an order of the vacant participation entry of the first financial product.

4. The method of claim 3, wherein the searching for of a first matching financial product searches for the first matching financial product, which has a receipt time of the payout amount of the vacant participation entry of the first financial product matching the desired receipt time, has the payout amount of the vacant participation entry of the first financial product which corresponds to the desired payout amount, and has the agreed interest rate of the vacant participation entry of the first financial product which is greater than the desired agreed interest rate, from the one or more first financial products, and
wherein the receipt time of the payout amount of the vacant participation entry of the first financial product is calculated on the basis of a reception time of the search request message and the order of the vacant participation entry of the first financial product.

5. The method of claim 3, wherein the detailed information of the first virtual participation entry includes a payout amount, a agreed interest rate, and an order of the first virtual participation entry, and
wherein the setting of detailed information of the first virtual participation entry:
sets the payout amount of the first virtual participation entry to be the same as a payout amount of the vacant participation entry of the first matching financial product;
sets the agreed interest rate of the first virtual participation entry to be lower than a agreed interest rate of the vacant participation entry of the first matching financial product and to be higher than the desired agreed interest rate; and
sets an order of the first virtual participation entry on the basis of a reception time of the search request message and the desired receipt time.

6. The method of claim 1, wherein the first virtual participation entry is included in a virtual financial product having a plurality of virtual participation entries, and
wherein the number of the plurality of virtual participation entries is set to be smaller than the number of a plurality of virtual participation entries of the first matching financial product.

7. The method of claim 1, further comprising:
after the receiving of the search request message from a user terminal, searching for a second matching financial product, which is a second financial product matching the search condition information among at least one second financial products that are being opened,
wherein the transmitting of the search completion message to the user terminal transmits the search completion message, which further includes detailed information of a recruitment participation entry corresponding to the search condition information among a plurality of participation entries of the second matching financial product, to the user terminal.

8. The method of claim 7, further comprising:
after the transmitting of the search completion message to the user terminal, allowing the user to participate as a participant of the recruitment participation entry of the second matching financial product when a participation request message for the recruitment participation entry, which is response to the search completion message, is received from the user terminal.

9. A non-transitory computer-readable recording medium on which programs for executing the method of claim 1 in a computer are recorded.

10. A financial service server operating a Rotating Savings and Credit Association (RoSCA)-type online financial product, the financial service server comprising:
a communication unit receiving a search request message including search condition information for a desired financial product of a user from a user terminal; and
a processor unit searching for a first matching financial product, which is a first financial product matching the search condition information among at least one first financial products that have been opened and are in progress, and setting detailed information of a first virtual participation entry on the basis of detailed information of the vacant participation entry of the first matching financial product and the search condition information,
wherein a plurality of participation entries of the first financial product include a vacant participation entry in which a participant has terminated or is scheduled to terminate the first financial product, and
wherein the communication unit transmits a search completion message including the detailed information of the first virtual participation entry to the user terminal.
